(19) United States
(12) Patent Application Publication
(10) Pub. No.: US 2023/0201845 A1
(43) Pub. Date: Jun. 29, 2023

(54) MULTI-FUNCTION SPRAYHEAD

(71) Applicant: Kohler Co., Kohler, WI (US)

(72) Inventors: Jacob FRYE, Sheboygan Falls, WI (US); Perry D. ERICKSON, Sheboygan, WI (US)

(21) Appl. No.: 18/069,708

(22) Filed: Dec. 21, 2022

Related U.S. Application Data
(60) Provisional application No. 63/293,540, filed on Dec. 23, 2021.

(51) Int. Cl. B05B 1/16; B05B 12/00

(52) U.S. Cl. CPC B05B 1/1681; B05B 12/002; E03C 2201/30

(57) ABSTRACT

A fluid control valve includes a first portion, a second portion, and a third portion, which, when combined, define a first channel, a second channel, a third channel, and a fourth channel. Each of the channels is defined by a combination of at least two of the portions. The fluid control valve further includes a first diverter and a second diverter. The first diverter and the second diverter are each movable between a first position and a second position to selectively control a flow of fluid through at least one of the chambers.

### CROSS-REFERENCE TO RELATED APPLICATIONS

The present application claims the benefit of U.S. Provisional Application 63/293,540, filed Dec. 23, 2021, which is incorporated herein by reference in its entirety.

### BACKGROUND

The present invention relates generally to the field of valves for directing fluids to multiple outlets. More specifically, the disclosure relates to sprayhead assemblies for use in faucets for directing fluid (e.g., water) to one or more outlets to thereby provide multiple functions of the sprayhead.

Faucets may include a body and a sprayhead from which water is emitted. Conventional sprayheads may include a valve for switching between two functions, for example, aerated and non-aerated water streams. There is a need for an improved valve to distribute water between functional outlets. There is further a need for a valve that provides a sprayhead having more than two functions.

### SUMMARY

At least one embodiment relates to a fluid control valve having a first portion, a second portion, and a third portion, which when combined, define a first channel, a second channel, a third channel, and a fourth channel. Each of the channels are formed by a combination of at least two of the portions. The fluid control valve further includes a first diverter and a second diverter. The first diverter and the second diverter are each movable between a first position and a second position to selectively control the flow of fluid through at least one chamber.

In some embodiments, when the first diverter is in the first position, the inlet is fluidly coupled with the first chamber. In some embodiments, when the first diverter is in the second position, the inlet is fluidly coupled with the second chamber. In some embodiments, when the second diverter is in the first position, the second chamber is fluidly connected with the third chamber. In some embodiments, when the second diverter is in the second position, the second chamber is fluidly connected to the fourth chamber.

In some embodiments, the first chamber is fluidly connected with a first outlet member. In some embodiments, the first outlet member includes at least one nozzle.

In some embodiments, the third chamber is fluidly connected with a second outlet member. In some embodiments, the second outlet member is configured to provide an aerated output.

In some embodiments, the fourth chamber is fluidly connected with a third outlet member. In some embodiments, the third outlet member includes a plurality of nozzles.

Another embodiment relates to a water outlet device including a housing having a valve assembly, a first actuator, a second actuator, and an outlet assembly. The valve assembly includes a first portion, a second portion, and a third portion, which when combined, define a first channel, a second channel, a third channel, and a fourth channel. Each of the channels are formed by a combination of at least two of the sections. The valve assembly further includes a first diverter and a second diverter. The first diverter is coupled to the first actuator and the second diverter is coupled to the second actuator. The first diverter and the second diverter are movable between a first position and a second position. The outlet assembly is fluidly coupled to the valve assembly and receives a fluid from at least one channel of the valve assembly based on at the position of least one of the first diverter or the second diverter.

In some embodiments, when the first diverter is in the first position, the inlet is fluidly coupled with the first chamber. In some embodiments, when the first diverter is in the second position, the inlet is fluidly coupled with the second chamber. In some embodiments, when the second diverter is in the first position, the second chamber is fluidly connected with the third chamber. In some embodiments, when the second diverter is in the second position, the second chamber is fluidly connected to the fourth chamber.

In some embodiments, the valve assembly is at least partially enclosed by a housing.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is front perspective view of a sprayhead, according to some embodiments;

FIG. 2 is a rear perspective view of the sprayhead of FIG. 1, according to some embodiments;

FIG. 3 is a top view of the sprayhead of FIG. 1, with select portions of the housing removed for clarity, according to some embodiments;

FIG. 4 is a front view of the sprayhead of FIG. 1, according to some embodiments;

FIG. 5 is a side perspective view of the sprayhead of FIG. 1, according to some embodiments;

FIG. 6 is an exploded perspective view of the sprayhead of FIG. 1, according to some embodiments;

FIG. 7 is an exploded side perspective view of a portion of the sprayhead of FIG. 1, according to some embodiments;

FIG. 8 is a perspective view of a portion of the portion of FIG. 7, according to some embodiments;

FIG. 9 is a perspective view of a portion of the portion of FIG. 7, according to some embodiments;

FIG. 10 is a side perspective view of a portion of the portion of FIG. 7, according to some embodiments;

FIG. 11 is a side perspective view of a portion of the portion of FIG. 7, according to some embodiments;

FIG. 12 is a block diagram of a portion of the sprayhead of FIG. 1, according to some embodiments;

FIG. 13 is a cross sectional view of the sprayhead of FIG. 1 in a first mode of operation, according to some embodiments;

FIG. 14 is a perspective view of a portion of the sprayhead of FIG. 1, according to some embodiments;

FIG. 15 is a perspective view of a portion of the sprayhead of FIG. 1, according to some embodiments;

FIG. 16 is a cross sectional view of the sprayhead of FIG. 1 in a second mode of operation, according to some embodiments;

FIG. 17 is a perspective view of a portion of the sprayhead of FIG. 1, according to some embodiments;

FIG. 18 is a perspective view of a portion of the sprayhead of FIG. 1, according to some embodiments;

FIG. 19 is a cross sectional view of the sprayhead of FIG. 1 in a third mode of operation, according to some embodiments;

FIG. 20 is a perspective view of a portion of the sprayhead of FIG. 1, according to some embodiments;

FIG. 21 is a perspective view of a portion of the sprayhead of FIG. 1, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting. The various concepts introduced above and discussed in greater detail below may be implemented in any number of ways, as the described concepts are not limited to any particular manner of implementation. Examples of specific implementations and applications are provided primarily for illustrative purposes.

Referring generally to the FIGURES, a sprayhead is configured to provide multiple spray functions (e.g., spray modes, operational modes, etc.). The sprayhead may be configured for use with faucets or may be separate sprayers (e.g., side sprayers). The sprayhead may include a valve assembly (e.g., a fluid control valve) having one or more sections (e.g., modules, portions, etc.) defining one or more chambers. For example, the valve assembly may include three sections that, when combined, define a first chamber, a second chamber, a third chamber, and a fourth chamber. The sprayhead may also include an inlet configured to receive a supply of fluid (e.g., water). For example, the valve assembly may include the inlet. The valve assembly may include at least one diverter. For example, the valve assembly may include a first diverter and a second diverter. The first diverter may be movable between a first position and a second position. According to an exemplary embodiment, when the first diverter is in the second position, the first chamber is fluidly connected to the inlet and the second chamber is fluidly disconnected from the inlet; and when the first diverter is in the first position, the second chamber is fluidly connected to the inlet and the first chamber is fluidly disconnected from the inlet. The second diverter may be movable between a first position and a second position. According to an exemplary embodiment, when the second diverter is in the second position, the third chamber is fluidly connected to the second chamber; and wherein when the second diverter is in the first position, the fourth chamber is fluidly connected to the second chamber. The valve assembly may include one or more outlets. For example, the valve assembly may include a first outlet, a second outlet, and a third outlet. The first outlet may be fluidly connected to the first chamber, the second outlet may be fluidly connected to the third chamber, and the third outlet may be fluidly connected to the fourth chamber. According to an exemplary embodiment, when the second diverter is in the first position, the second outlet is fluidly connected to the second chamber, and when the second diverter is in the second position, the second outlet is fluidly disconnected from the second chamber.

The sprayhead may include one or more outlet members, where each outlet member is configured to provide a different spray function (e.g., mode of operation). For example, the sprayhead may include a first outlet member, a second outlet member, and a third outlet member. The first outlet member may include a first at least one nozzle that receives the fluid from the first chamber. The second outlet member may include a second at least one nozzle that is fluidly connected to the second chamber and the third chamber when the second diverter is in the first position. The third outlet member may include a plurality of nozzles that receive the fluid from the fourth chamber. The first at least one nozzle may provide a first function, the second at least one nozzle of the second outlet member may provide a second function different than the first function, and the plurality of nozzles may provide a third function different than the first and second functions.

A faucet sprayhead may include a valve which directs water between an aerated outlet and a non-aerated outlet. However, as faucet technology improves and specialized spray patterns may be used to more efficiently use water, there is a need for a valve which can distribute water to multiple functional outlets. According to various embodiments, the sprayhead has three or more possible functions. According to the exemplary embodiment shown, the sprayhead has three possible functions.

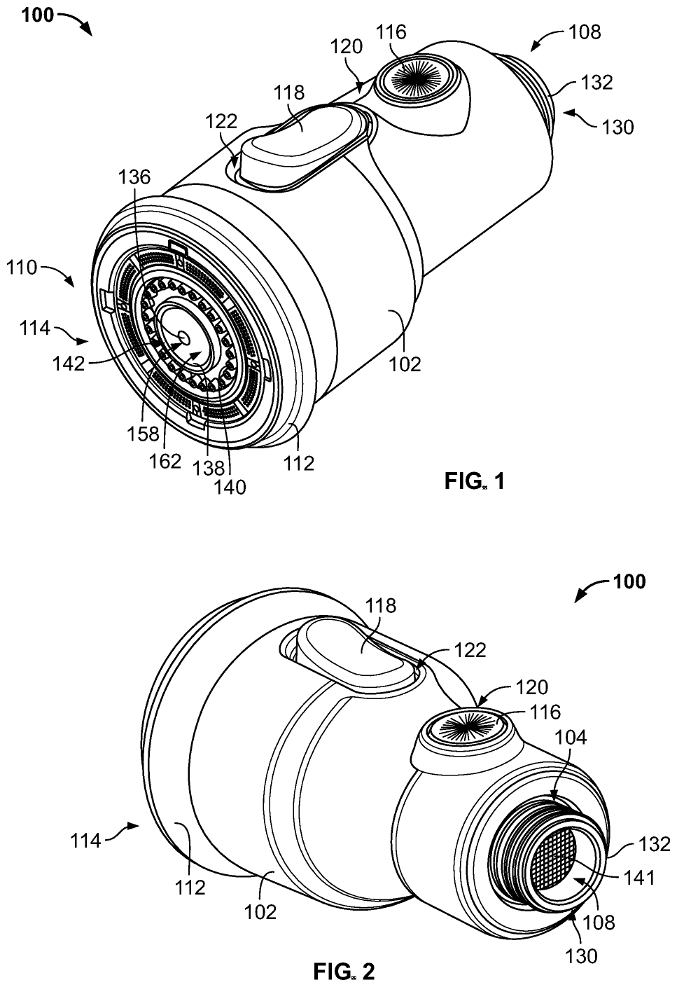

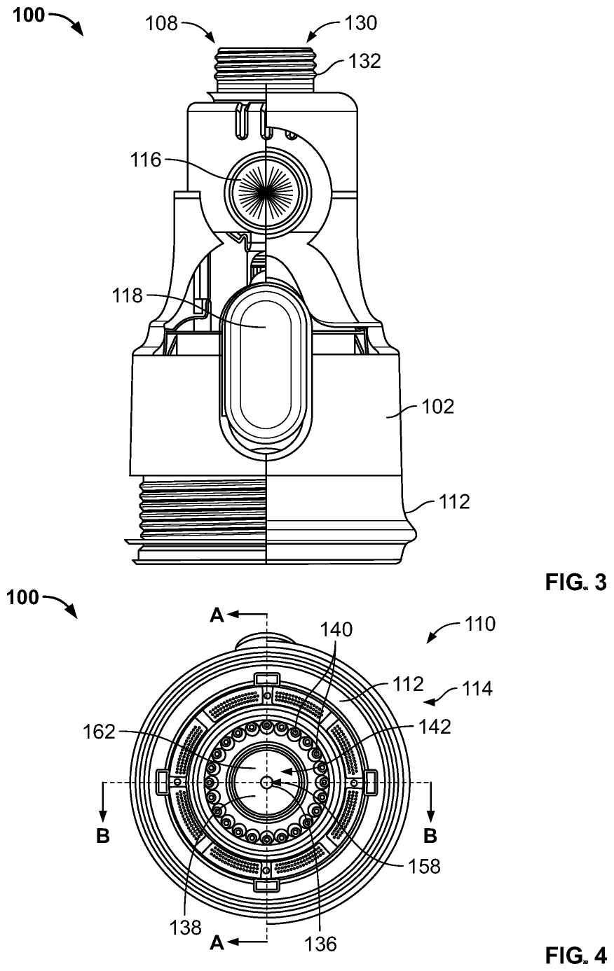

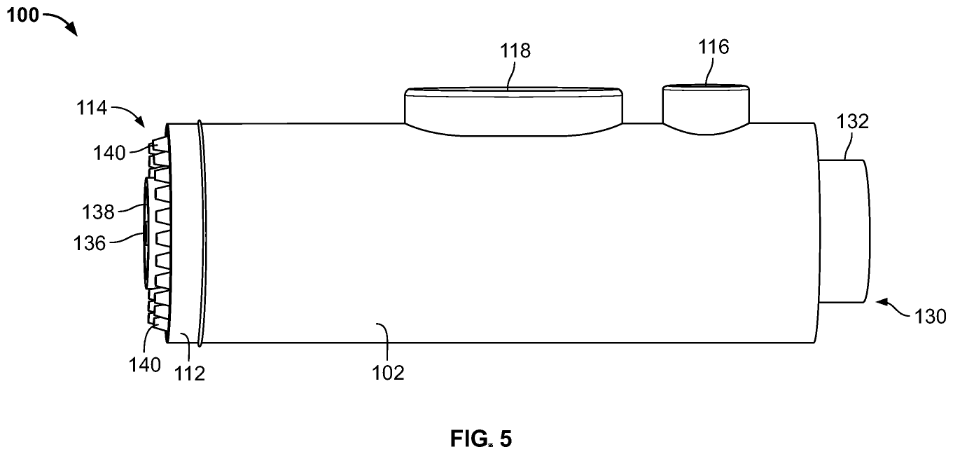

Referring to FIGS. 1-5, a water outlet device (e.g., sprayhead, showerhead, etc.) is shown as sprayhead 100. The sprayhead 100 may include a housing 102 (e.g., a casing, etc.) that is configured to house one or more elements of the sprayhead 100. The housing 102 may at least partially house (e.g., enclose, surround, etc.) a valve assembly 200.

In some embodiments, the housing 102 includes an outer wall having a first portion and a second portion, which house and surround at least a portion of the valve assembly 200. In other words, the outer wall of the housing 102 defines a cavity (e.g., chamber, etc.) for receiving at least a portion of the valve assembly 200 therein. The outer wall may include an opening therein. As shown, the outer wall of the housing 102 includes a first opening 104 disposed at a first end (e.g., an inlet end) of the housing 102 adjacent to the first portion and also includes a second opening 106 disposed at a second end (e.g., an outlet end) of the housing 102 adjacent to the second portion.

In some embodiments, the housing 102 is open on at least one end. In some embodiments, the sprayhead 100 includes an inlet area 108 and an outlet area 110. The housing 102 may at least partially extend between the inlet area 108 and the outlet area 110. In some embodiments, a cross sectional area of the housing 102 is substantially circular, rectangular, oval, triangular, or polygonal or any combination thereof. In some embodiments, the cross sectional area of the housing 102 varies in one or more dimensions of the housing 102. For example, as shown in FIGS. 1-4, the housing 102 has a larger outer cross sectional area near the outlet area 110 and a smaller outer cross sectional area near the inlet area 108, and includes cross sections having transitional geometries therebetween. In some embodiments, the housing 102 is substantially hollow, and the thickness of the wall(s) of the housing 102 may vary.

The housing 102 may include one or more supports for supporting the devices and assemblies within the housing 102. The housing 102 may be made of a material or combination of materials that is hydrophobic and/or corrosion resistant (e.g., stainless steel, aluminum, copper, bronze brass, plastic, glass, ceramic, resin, polymer, thermoset, thermoplastic, etc.). In some embodiments, the housing 102 is configured to provide structural support for the sprayhead 100. In some embodiments the housing 102 may be substantially rigid.

The housing 102 may include one or more than one feature configured to couple and/or secure another element of the sprayhead 100 to the housing. For example, the housing 102 may include a feature, such as threads, that the outlet assembly 114 detachably (e.g., removably, selectively, etc.) couples thereto. As shown, an outer portion 112 of the outlet assembly 114 includes external threads that mesh with internal threads of the outer wall (e.g., second portion) of the housing 102 to detachably couple the outlet assembly 114 to the housing 102. In some embodiments, the housing 102 may include a feature that facilitates coupling of the valve assembly 200 to the housing 102.

The sprayhead 100 may further include at least one actuator configured to control operation of the sprayhead 100 to switch between two or more operational modes (e.g., spraying functions). As shown, the sprayhead 100 includes a first actuator shown as button 116, and a second actuator shown as toggle 118. Each actuator may be configured as a toggle, switch, a button, or other suitable configurations. The sprayhead 100 may include one or more features (e.g., studs, pivots, guides, bosses, protrusions, axles, etc.) that are configured to guide and/or facilitate movement of the actuator. Actuation of an actuator causes a change in operation (e.g., volume control, function control, etc.) of the sprayhead 100.

The housing 102 may further include one or more additional openings, such as, for example, to receive the one or more actuators for controlling operation of the sprayhead 100. As shown in FIGS. 1-3, the housing 102 includes a third opening 120 that is configured to receive the button 116 and a fourth opening 122 that is configured to receive the toggle 118. The third opening 120 may have a generally circular cross-sectional shape to define a cylindrical bore in the housing 102 to receive the button 116, or may have any suitable shape that is tailored to the shape of the actuator. The fourth opening 122 may have a generally elongated (e.g., elliptical, slotted, etc.) cross-sectional shape to define a bore in the housing 102 that has a corresponding shape as the toggle 118, or may have any suitable shape that is tailored to the shape of the actuator.

As shown in FIGS. 1-3 and 5, the sprayhead 100 includes an inlet 130 configured to receive a supply of fluid. The sprayhead 100 may include a connector 132 configured to couple the sprayhead 100 to another member, such as a faucet, a supply hose, etc. The connector 132 may be configured proximate the inlet 130. For example, the connector 132 may define the inlet 130, which is fluidly connected to (e.g., in fluid communication with) the valve assembly 200 of the sprayhead 100 to introduce the fluid into the valve assembly 200. According to an exemplary embodiment, the connector 132 is configured to detachably couple to a hose through threads, where the hose extends through a spout of a faucet such that the sprayhead 100 is fluidly coupled to the faucet. The hose may have a telescopic arrangement (e.g., configuration, connection, etc.) relative to the spout. In other words, the connection allows the sprayhead 100 to be decoupled from the faucet and the hose extracted from the spout, and also allows the hose to be retracted into the spout and the sprayhead 100 to be coupled to the faucet. In some embodiments, the sprayhead 100 may be selectively decoupled from the hose to facilitate cleaning or replacement of one or more of the components of the hose and/or sprayhead 100.

A portion of the sprayhead 100, such as the connector 132 and/or the valve assembly 200, is configured to extend through the first opening 104. The fluid directed into the inlet 130 flows to the one or more outlets (e.g., outlet members, etc.), which are generally located opposite the inlet 130. The one or more outlet members may be disposed in the second opening 106. As shown, the outlet assembly 114 is disposed in the second opening 106. In some embodiments, the outlet assembly 114 includes a first outlet member 136, a second outlet member 138, and a third outlet member 140, which are disposed in the second opening 106 of the housing 102, such that the fluid directed from the outlet members are discharged from the second end of the housing 102 having the second opening 106.

The sprayhead 100 may optionally include a screen member 141 disposed in the inlet 130 to filter any debris or sediment that may pass into the inlet 130 of the sprayhead 100. As shown in FIG. 2, the screen member 141 may be disposed in the inlet 130. The screen member 141 may be a mesh screen that is configured to a predetermined size (e.g., orifice, porosity, etc.). A flow control (e.g., collar) may optionally be provided adjacent to the screen member 141. The flow control and/or the screen member 141 may couple to the sprayhead 100, such as to the valve assembly 200. For example, an inner surface of the valve assembly 200 defining the inlet 130 may include a detent member (e.g., raised member) that detachably secures the screen member 141 and the flow control in place in the inlet 130.

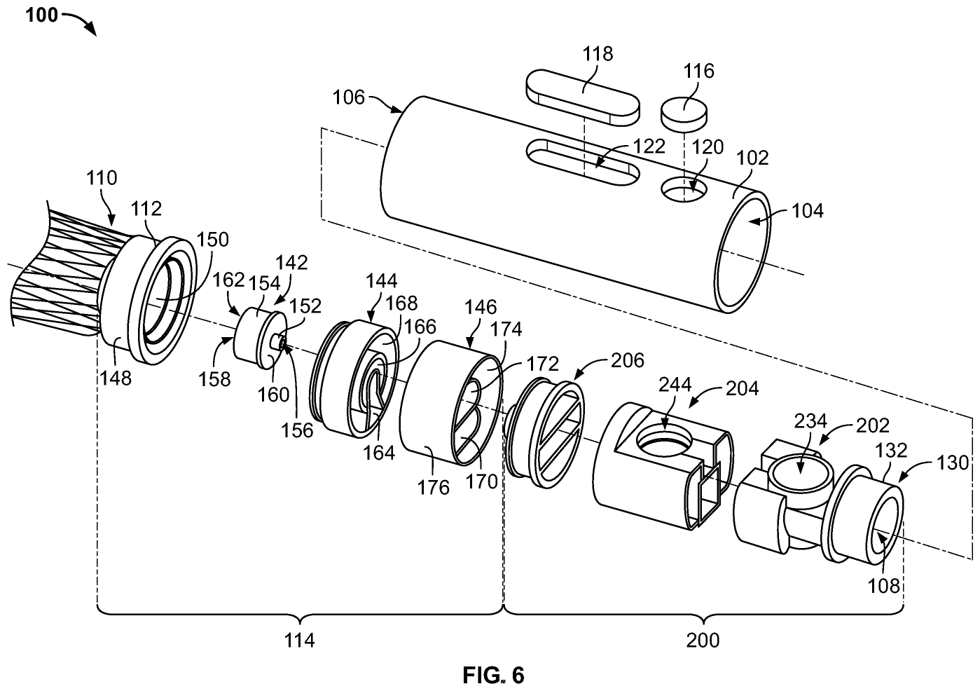

Referring now to FIG. 6, the sprayhead 100 includes the outlet assembly 114, the valve assembly 200, the housing 102, the button 116, and the toggle 118. The outlet assembly 114 may include an outer portion 112, an insert 142, a distributor 144, and an expander 146. The outer portion 112 may be configured to couple with the housing 102 and house at least a portion of the insert 142. The outer portion 112 may include an outer wall 148 and at least one an inner wall 150. In some embodiments, both the outer wall 148 and the inner wall 150 are substantially cylindrical. In some embodiments, the outer wall 148 and the inner wall 150 may be substantially concentric, and the inner wall 150 may be at least partially nested within the outer wall 148. The outer wall 148 and the inner wall 150 may include features and openings which define at least one outlet of the third outlet member 140. The third outlet member 140 may include one or more fluid outlet structures (e.g., nozzles), which may be or include frustum, conical, cylindrical, and/or other suitable shapes. In some embodiments, the outlet structures are positioned in a pattern about a center of the outer portion 112. The inner wall 150 may be sized and shaped to engage, interface with, and/or partially house the insert 142. The insert 142 may be removably coupled with the outer portion 112 to facilitate cleaning one or more of the components of the sprayhead 100.

In some embodiments, the insert 142 may be or include the first outlet member 136 and/or the second outlet member 138. The insert 142 may include a first passage 152 (e.g., a jet outlet passage) separate from a second passage 154 (e.g., an aerated outlet passage). The first passage 152 may include a first passage inlet 156 fluidly connected to a first passage outlet 158. The first passage 152 may have a flow area that is different than (e.g., smaller than) a flow area of the second passage 154 and/or the flow area of the third outlet member 140. In some embodiments, the fluid flow velocity through the first passage 152 is higher than through the second passage 154. The second passage 154 may include a second passage inlet 160 fluidly connected to a second passage outlet 162. In some embodiments, the second passage 154 may include features (e.g., structures, channels, etc.) that introduce gas (e.g., air bubbles) into the fluid flowing through the second passage 154.

In some embodiments, the distributor 144 includes a first distributor passage 164, a second distributor passage 166, and a third distributor passage 168. In some embodiments, each of the distributor passages 164, 166, 168 include an respective inlet fluidly connected with a respective outlet. As shown, the inlets of the second distributor passage 166 and third distributor passage 168 may be at least partially circular. In some embodiments, the outlet of the second distributor passage 166 and/or the outlet of the third distributor passage 168 are circular. For example, a fluid may enter the distributor 144 through the inlet of one of the passages 164, 166, 168 in a first position, and exit the distributor 144 in a second position different from the first position. For example, the distributor 144 may be configured to generate a supply of water having a large circular flow area on the outlet based on a different flow area at the inlet (e.g., smaller and/or square-shaped flow area, etc.). For example, the outlets of the distributor 144 may engage with at least one of the inlet of the first passage 152 (e.g., to connect with the first outlet member 136), the inlet of the second passage 154 (e.g., to connect with the second outlet member 138), and/or the inlet of the third passage (e.g., to connect with the third outlet member 140) which may be different than one or more of the inlets of the distributor 144. In some embodiments, the inlets (e.g., the first inlet, the second inlet, and the third inlet) of the distributor 144 may be shaped similarly to one or more outlets of the components positioned upstream the distributor 144 (e.g., outlets of the expander 146, outlets of the valve assembly 200, etc.).

In some embodiments, the expander 146 includes first expander passage 170, a second expander passage 172, and a third expander passage 174. In some embodiments, each of the expander passages 170, 172, 174 include a respective inlet fluidly connected with a respective outlet. As shown, the inlets of the expander passages 170, 172, 174 may be shaped, sized, and positioned to receive a fluid from one or more outlets of the valve assembly 200. The outlets of the expander passages 170, 172, 174 may be shaped, sized, and positioned to output fluid received at a respective inlet of the expander 146 to an inlet of a downstream component (e.g., the distributor 144). In some embodiments, the inlet side (e.g., upstream side) of the expander 146 may be configured to at least partially surround, house, or enclose at least a portion of the valve assembly 200. For example, the expander 146 may have an outer wall 176 that extends beyond the inlets and passages of the expander 146. In some embodiments, the outer wall 176 of the expander 146 may be shaped and sized to receive some or all of the valve assembly 200. For example, the outer wall 176 of the expander 146 may at least partially surround the valve assembly 200.

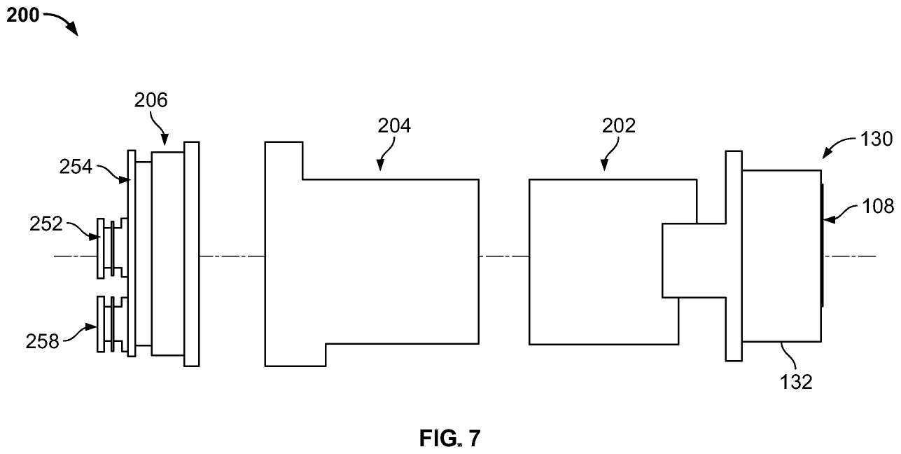

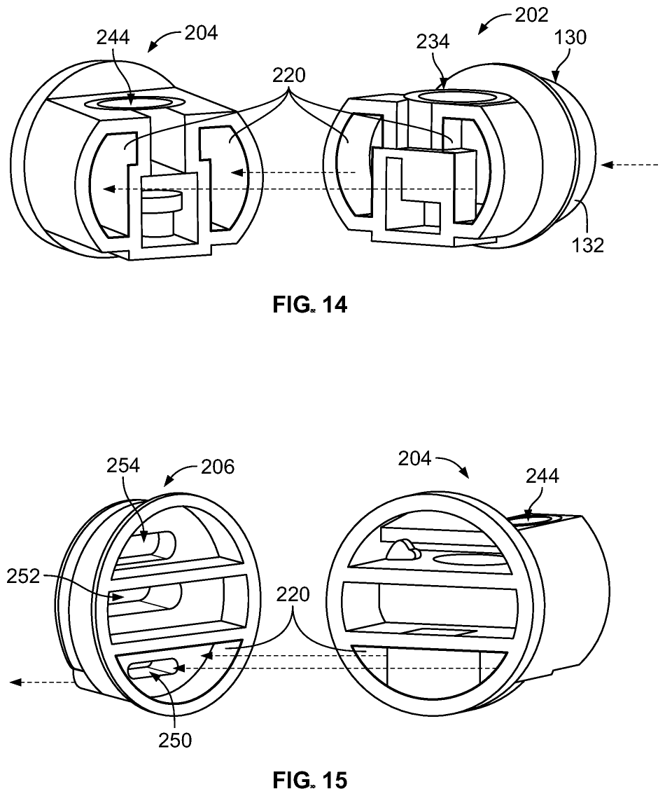

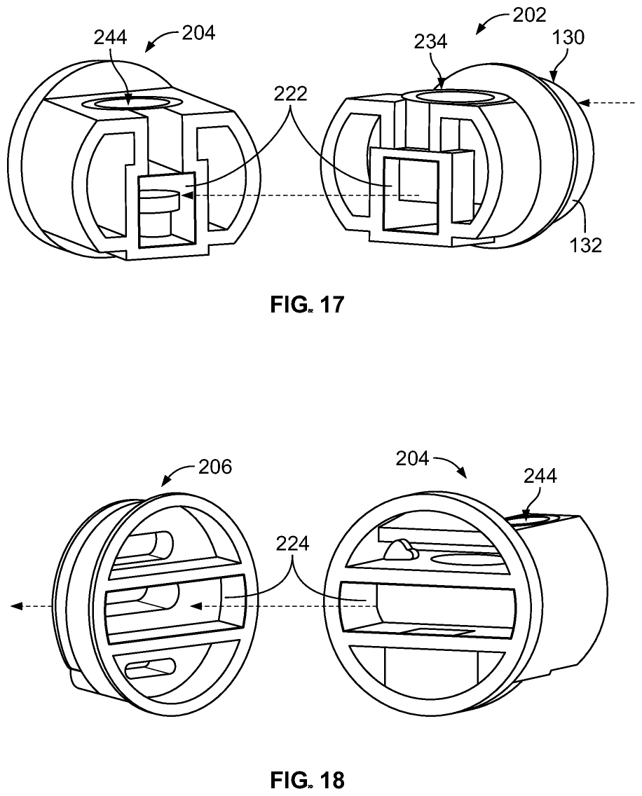

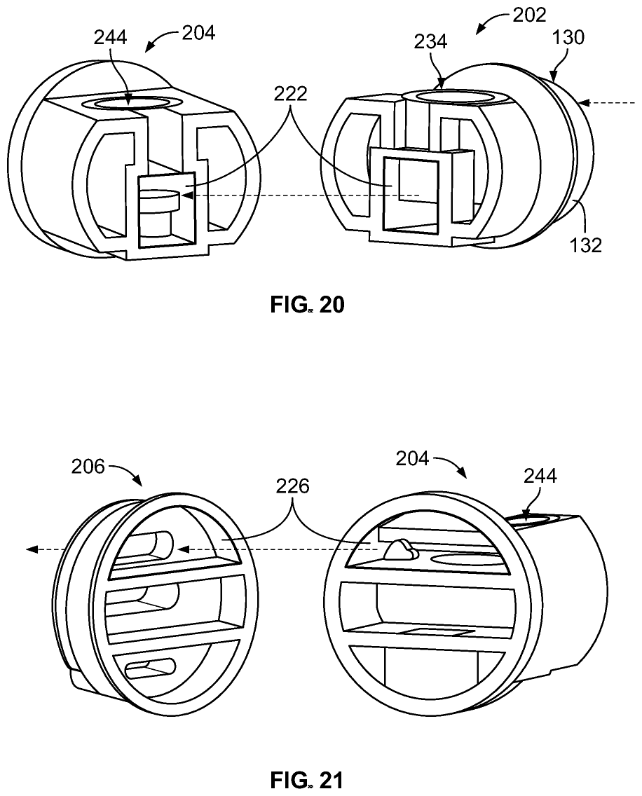

As shown in FIGS. 6-20, the valve assembly 200 (e.g., fluid control valve) includes more than one portion (e.g., section, subcomponent, subassembly, module, etc.). As shown, the valve assembly 200 includes a first portion 202, a second portion 204, and a third portion 206. In some embodiments, the valve assembly 200 has more or fewer than three portions (e.g., two portions, four portions, five portions, six portions, etc.). Each of the portions 202, 204, 206 may be formed using a single piece of material (e.g., molded, forged, cast, milled, etc.). In some embodiments, the valve assembly 200 can be customized by rearranging or adding portions (e.g., sections, modules) of the valve assembly 200. In some embodiments, the portions of the valve assembly 200 may be shaped, sized, or configured to facilitate an inspection of one or more internal chambers formed by one or more portions of the valve assembly 200. The ability to at least partially inspect each of the internal chambers formed by the portions of the valve assembly 200 may facilitate an improved product performance and reliability and may also reduce the likelihood of undetected manufacturing defects. For example, a defect in a forming process (e.g., porosity, bubbles, blisters, burrs, flow marks, short molding, etc.) may be identified in the valve assembly 200 prior to assembly of the valve assembly 200 due to the access provided to the chambers of the valve assembly 200 between the portions (e.g., first portion 202, second portion 204, third portion 206, etc.) before combining the portions. In some embodiments, the portions 202, 204, 206 of the valve assembly 200 may be formed separately (e.g., in separate dies, in additive manufacturing operations, in casting operations, in injection molding operations, etc.) and combined (e.g., welded, bonded, fastened, etc.) to define at least one chamber of the valve assembly 200.

In some embodiments, the first portion 202 includes an inlet that is configured to receive a supply of fluid. In some embodiments, the inlet of the first portion 202 is the inlet 130 of the sprayhead 100. In such embodiments, the connector 132 may optionally be integrally formed with the first portion 202. In some embodiments, the inlet of the first portion 202 is separately formed from the inlet 130 (and/or the connector 132) of the sprayhead 100. In such embodiments, the inlet of the first portion 202 may be in fluid communication with (e.g., fluidly connected to) the inlet 130.

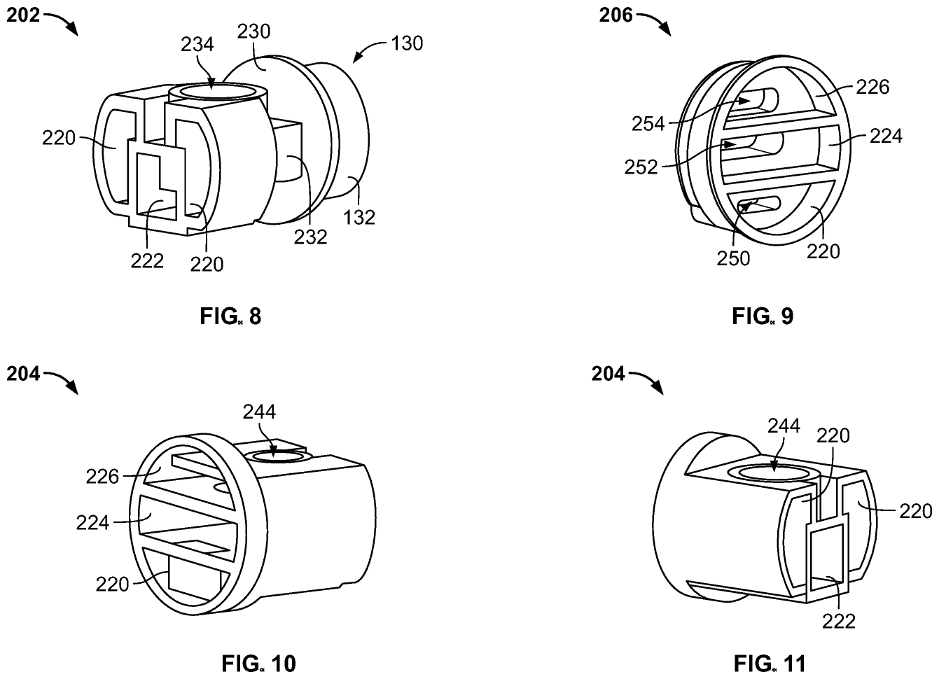

The valve assembly 200 may also include one or more than one chamber that is configured to receive the fluid. As shown in FIGS. 8-21, the portions 202, 204, 206 of the valve assembly 200 define a first chamber 220, a second chamber 222, and a third chamber 224, and a fourth chamber 226, where each chamber is configured to selectively receive the fluid depending on the mode of operation of the sprayhead 100 (e.g., the arrangement of the valve assembly 200). The one or more chambers may be defined by one or more of the portions 202, 204, 206, either alone or in combination with other elements of the sprayhead 100. As shown, the first portion 202 is the inlet end of the valve assembly 200 and the third portion 206 is the outlet end of the valve assembly 200.

In some embodiments, the first portion 202 may be configured to include one or more circular, elliptical, and/or other suitably shaped members (e.g., sections, walls, etc.) to help define the one or more chambers of the valve assembly 200. For example, the first portion 202 may include members that help define the inlet 130, the connector 132, the first chamber 220, the second chamber 222, the third chamber 224, and/or the fourth chamber 226. As shown, the first portion 202 a includes a shoulder 230, a neck 232, a first diverter housing 234, a portion of the first chamber 220, and a portion of the second chamber 222. In some embodiments, the first chamber 220 and the second chamber 222 are downstream of the first diverter housing 234 and inlet 130 such that a diverter disposed within the first diverter housing 234 may control (e.g., regulate, block, facilitate, etc.) a flow of fluid through the first chamber 220 and the second chamber 222.

In some embodiments, the second portion 204 may be configured to include one or more circular, elliptical, and/or other suitably shaped members (e.g., sections, walls, etc.) to help define the one or more chambers of the valve assembly 200. For example, the second portion 204 may include members that help define the first chamber 220, second chamber 222, third chamber 224 and fourth chamber 226, and the second diverter housing 244. As shown, the second portion 204 a includes and defines a second diverter housing 244, a portion of the first chamber 220, a portion of the second chamber 222, a portion of the third chamber 224 and a portion of the fourth chamber 226. In some embodiments, the second chamber 222 is upstream of the second diverter housing 244. In some embodiments, the third chamber 224 and fourth chamber 226 are downstream of the second diverter housing 244 such that a diverter housed within the second diverter housing 244 may control (e.g., regulate, inhibit, enable, etc.) a flow of fluid through the third chamber 224 and the fourth chamber 226. In some embodiments, the diverter disposed in the second diverter housing 244 may receive a flow of fluid from the second chamber 222 and selectively provide the flow of fluid to the third chamber 224 or the fourth chamber 226.

In some embodiments, the third portion 206 may be configured to include one or more circular, elliptical, and/or other suitably shaped members (e.g., sections, walls, etc.) to help define the one or more chambers of the valve assembly 200. For example, the third portion 206 may include members that help define the first chamber 220, the second chamber 222, the third chamber 224, and/or the fourth chamber 226. As shown, the third portion 206 includes and defines a portion of the first chamber 220, a portion of the third chamber 226, and a portion of the fourth chamber 226. In some embodiments, the third chamber 224 and the fourth chamber 226 are downstream of the second diverter housing 244, and the first chamber 220 is downstream of the first diverter housing 234. In some embodiments, the third portion includes outlets (e.g., orifices, apertures, etc.) that are configured to direct the flow of fluid through the valve assembly 200 to the outlet assembly 114. For example, a flow of fluid through the first chamber 220 may be directed through a first valve assembly outlet 250 of the third portion 206 into an inlet of the outlet assembly 114 (e.g., an inlet of the first expander passage 170). In some embodiments, the third portion 206 is configured to supply a flow of fluid from the third chamber 224 to a second valve assembly outlet 252 to an inlet of the outlet assembly 114 (e.g., an inlet of the second expander passage 172). In some embodiments, the third portion 206 is configured to supply a flow of fluid from the fourth chamber 226 to a third valve assembly outlet 254 to an inlet of the outlet assembly 114 (e.g., an inlet of the third expander passage 174). In some embodiments, the third portion 206 includes a pivot, about which an actuator (e.g., the toggle 118) is configured to pivot. In some embodiments, the valve assembly outlets 250, 252, 254 include features within the chambers of the valve system. For example, the valve assembly outlets 250, 252, 254 may include an orifice, rib, and/or other features to change a characteristic the flow of fluid exiting the valve assembly 200. In some embodiments, the first chamber 220 is defined by the fluid path between the first diverter 240 and the first outlet member 136. In some embodiments, the second chamber 222 is defined by the fluid path between the first diverter 240 and the second diverter 242. In some embodiments, the third chamber 224 is defined by the fluid path between the second diverter 242 and the second outlet member 138. In some embodiments, the fourth chamber 226 is defined by the fluid path between the second diverter 242 and the third outlet member 140.

A plurality of walls, dividers, and other structures of the valve assembly 200 may advantageously allow for the valve assembly 200 to include multiple chambers (e.g., chambers 220, 222, 224, 226), which supply fluid to multiple outlets (e.g., outlet members 136, 138, 140 of the outlet assembly 114), in a relative small size (e.g., cross-section). Thus, the sprayhead 100 can provide multiple spray functions and still have a relatively compact size.

In some embodiments, the components of the outlet assembly 114 and the components of the valve assembly 200 include a substantially flat surface on two opposing ends (e.g., the upstream end and the downstream end) to facilitate coupling (e.g., welding, bonding, attaching, assembling, fluidly coupling, etc.) the respective components together to form an assembly (e.g., valve assembly 200, outlet assembly 114, etc.). In some embodiments, the components of the outlet assembly 114 and the components of the valve assembly 200 include features (e.g., protrusions, ribs, threading, etc.) that facilitate interlocking the components of the valve assembly 200 and/or the outlet assembly 114. In some embodiments, one or more of the interfaces (e.g., contact areas) between the components of the sprayhead 100 (e.g., valve assembly 200, outlet assembly 114, housing 102, etc.) may include a fluid sealing component (e.g., gasket, seal, rubber o-ring, etc.) and/or a fluid sealing material (e.g., sealant, glue, adhesive, etc.). In some embodiments, one or more of the components of the valve assembly 200 may be coupled with the outlet assembly 114. For example, the valve assembly 200 may be welded together with one or more components of the outlet assembly 114. For example, the third portion 206 of the valve assembly 200 may be coupled to at least one of the expander 146, distributor 144, insert 142, or outer portion 112. In some embodiments, the first portion 202, second portion 204, and third portion 206 are coupled (e.g., welded, bonded, etc.) to form the valve assembly 200. In some embodiments, the expander 146 and distributor 144 are coupled (e.g., welded, bonded, etc.) to form a portion of the outlet assembly 114.

In some embodiments, the valve assembly 200 includes one or more than one diverter (e.g., divert piston, piston, valve stem, etc.). As shown, the valve assembly 200 includes a first diverter 240 and a second diverter 242, where the first diverter 240 and the second diverter 242 are movable within the valve assembly 200 to control the fluid flow between the first chamber 220, the second chamber 222, the third chamber 224, and/or the fourth chamber 226. As shown, the first diverter 240 and the second diverter 242 are configured to be at least partially housed by the first diverter housing 234 and the second diverter housing 244. In some embodiments, the first diverter 240 may receive a force from an actuator (e.g., button 116) to selectively reposition the first diverter 240 between at least a first position and a second position. In some embodiments, the second diverter 242 may receive a force from an actuator (e.g., toggle 118) to selectively reposition the second diverter 242 between at least a first position and a second position.

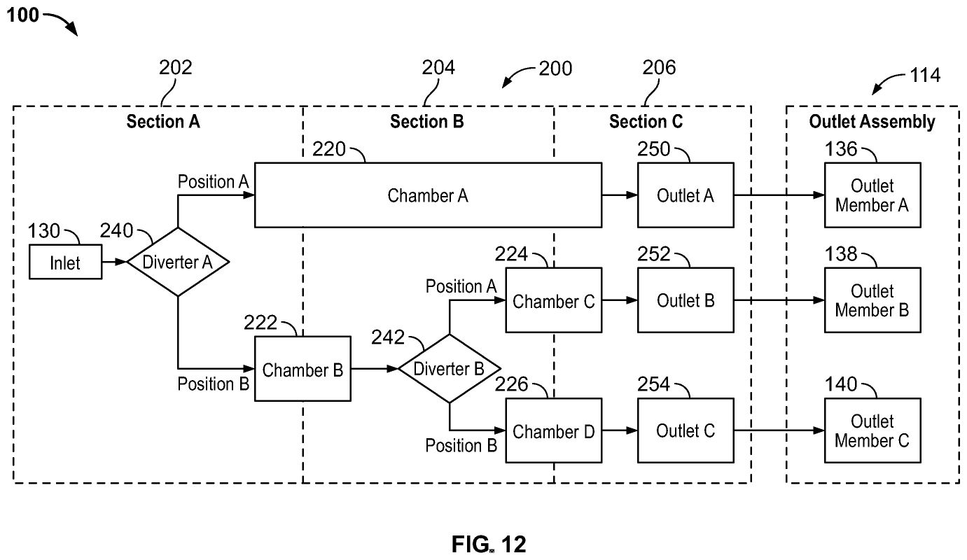

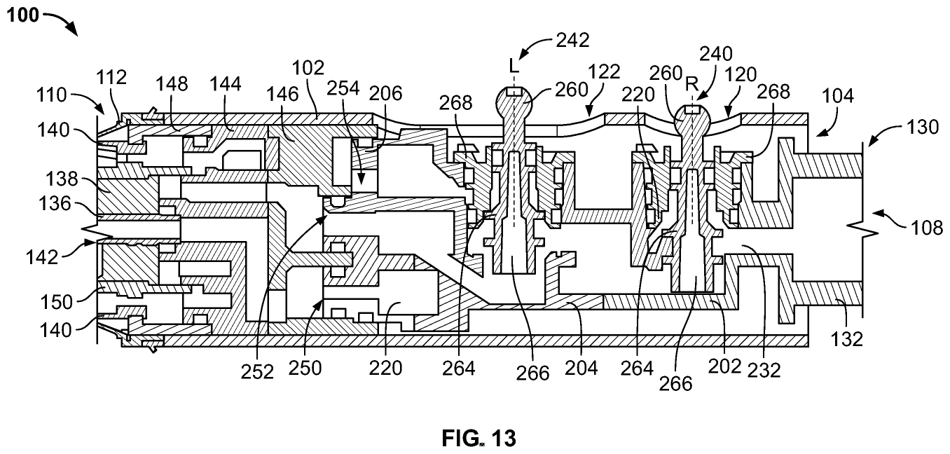

As shown in FIGS. 12-21, the first diverter 240 is movable between a first position (e.g., upward position, non-depressed position) and a second position (e.g., downward position, depressed position). FIG. 13 illustrates the first diverter 240 in the second position. When the first diverter 240 is in the second position, the first chamber 220 is fluidly connected to the inlet 130 and the second chamber 222 is fluidly disconnected from the inlet 130, such that the fluid flow is directed from the inlet 130 to the first chamber 220. Accordingly, no fluid is directed into the second chamber 222 when the first diverter 240 is the second position. When the first diverter 240 is in the first position, the second chamber 222 is fluidly connected to the inlet 130 and the first chamber 220 is fluidly disconnected from the inlet 130, such that the fluid flow is directed from the inlet 130 to the second chamber 222. Accordingly, no fluid is directed into the first chamber 220 when the first diverter 240 is in the first position.

As shown in FIGS. 1-6, 13, 16, and 19, the button 116 is configured to move (e.g., slide, translate, etc.) the first diverter 240 along direction R between its first and second positions when actuated (e.g., depressed) by a user of the sprayhead 100. Thus, a portion of the first diverter 240 may be coupled directly (or indirectly through another element of the sprayhead 100) to the button 116, such that movement of the button 116 results in a corresponding movement of the first diverter 240. For example, a first end 260 of the first diverter 240 may be coupled to the button 116. The button 116 may move relative to, for example, the housing 102.

In some embodiments, the first diverter 240 includes a second end 262, and a sealing portion 264, which may be provided between the first and second ends 260, 262. As shown, the sealing portion 264 is configured to provide a seal between the first diverter 240 and a portion of the valve assembly 200 (e.g., a portion of the first portion 202) to prevent the fluid from passing beyond the seal. For example, the sealing portion 264 may seal-off (e.g., fluidly disconnect) the second chamber 222 to prevent fluid from passing from the inlet 130 to the second chamber 222 when the first diverter 240 is configured in the second position. Also, for example, the sealing portion 264 may seal-off the first chamber 220 to prevent fluid from passing from the inlet 130 to the first chamber 220 when the first diverter 240 is configured in the first position.

In some embodiments, the first diverter 240 is configured generally as a piston (e.g., has a piston shape). The first end 260 a may have a generally cylindrical shape, which may include a feature, such as an undercut section (e.g., recess, channel, etc.), ball, or other feature that is configured to receive a portion of the button 116 to couple the first diverter 240 and button 116. The button 116 may include a flexible detent member that expands when moving over the non-undercut portion of the first end 260, then snaps into a mechanical locking arrangement with the undercut when the detent member engages the undercut. The second end 262 may have a generally cylindrical shape, conical shape, or any suitable shape. The sealing portion 264 may have a generally cylindrical shape that is disposed closer to the second end 262. However, it is noted that the shape of the first diverter 240, as well as the location of the sealing portion 264, can be tailored to the geometry of the valve assembly 200. The sealing portion 264 may include a raised (e.g., an outwardly extending) portion relative to the second end 262 (and/or the first end 260). In some embodiments, the sealing portion 264 is configured as a shoulder extending away from the second end 262. The sealing portion 264 may optionally include features (e.g., a channel, groove, etc.) for accommodating a sealing member (e.g., a seal, an o-ring, etc.).

The valve assembly 200 may optionally include a biasing member that is configured to bias the first diverter 240 in a direction. In some embodiments, the biasing member is in the form of a coil spring (e.g., a helical spring, a compression spring, an extension spring, etc.) configured to bias the first diverter 240 from the second position (e.g., the user depressed position) toward the first position (e.g., the pre-user depressed position). In this arrangement, a force from the biasing member may advantageously be in an opposing (e.g., counteracting) direction than the force of the user depressing the button 116. When the user depresses the button 116, such as to the second position, the biasing member is compressed thereby storing energy. Once the user releases the force depressing the button 116, the biasing member exerts a force from the stored energy to return the button 116 to the first position.

The biasing member may have a first portion (e.g., a first end) that engages the first diverter 240 and a second portion (e.g., a second end) that engages a portion of another element of the valve assembly 200 to impart a biasing force between the first diverter 240 and the other element. As shown, the second end 262 of the first diverter 240 includes a bore 266 that receives a portion of the biasing member. The bore 266 may have a generally cylindrical shape, according to one example, to receive and retain the biasing member in the form of a coil spring. In some embodiments, the first diverter 240 may include a post disposed on the first portion 202, and may have a generally cylindrical shape, according to one example. The first diverter housing 234 may also help guide movement of the first diverter 240, such as by maintaining the position (e.g., the radial position, etc.) of the first diverter 240 relative to the valve assembly 200 as the first diverter 240 moves between the first and second positions in the radial direction. This arrangement may advantageously help the first diverter 240 provide a good and repeatable seal with the valve assembly 200.

The valve assembly 200 may optionally include additional elements (e.g., components, members, etc.) to help retain one or more diverters (e.g., the first diverter 240, the second diverter 242) and/or seal the chambers 220, 222, 224, 226. The first diverter 240 may include a support sleeve 268 to support the first diverter 240, such as during movement thereof. The support sleeve 268 may include an outer wall that is shaped to complement the shape of the first diverter housing 234 to maintain the relative position between the support sleeve 268 and the first portion 202. The outer wall may include one or more than one channel that is configured to receive a corresponding number of sealing members therein. The outer wall may include features (e.g., seals, shoulders, flanges, etc.) to facilitate a seal between the support sleeve 268 and the first diverter housing 234. In some embodiments, the outer wall includes one or more openings, such as one or two pair of opposing openings, that allow fluid to flow from the inlet 130 to one of the downstream chambers (e.g., the first chamber 220, the second chamber 222, etc.). The support sleeve 268 also includes an inner wall that extends inwardly from the outer wall and is configured to help maintain the position (e.g., concentricity) of the first diverter 240 (e.g., an end thereof) relative to the support sleeve 268. The inner wall may include an opening defining an inner surface, which may contact an outer surface of the first diverter 240 to maintain the relative position of the diverter, and act as a guide to the diverter during its movement.

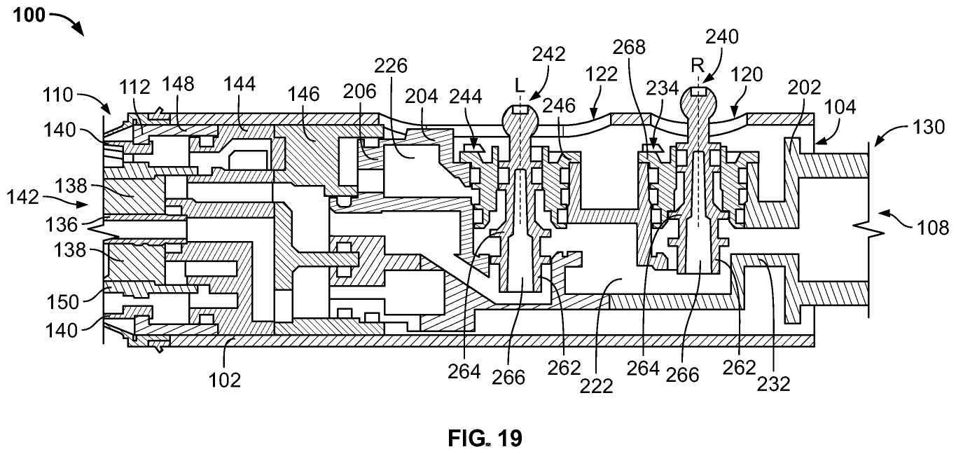

In some embodiments, the second diverter 242 is movable between a first position and a second position. FIG. 19 illustrates the second diverter 242 in a second position. The second diverter 242 may have some or all of the features described with respect to the first diverter 240. As shown in FIGS. 13, 16, and 19, the second diverter 242 is configured to move within the valve assembly 200 in the longitudinal direction L between the first and second positions. For example, at least a portion of the second diverter 242 may be disposed in a portion (e.g., third portion 206) of the valve assembly 200, such that the second diverter 242 moves in the longitudinal direction L within the valve assembly 200. In some embodiments, actuation of the second actuator (e.g., toggle 118) between its positions moves the second diverter 242. For example, the toggle 118 may be operatively coupled to the second diverter 242 such that actuation of the toggle 118 moves (e.g., slides, translates, pivots, etc.) a mechanism and in-turn moves the second diverter 242 between the first and second positions.

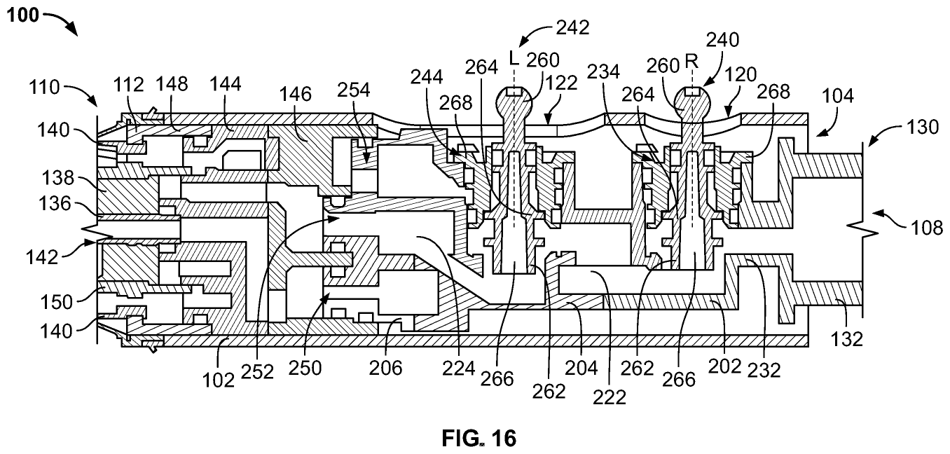

In some embodiments, when the second diverter 242 is in the second position, the fourth chamber 226 is fluidly connected to (e.g., in fluid communication with) the second chamber 222, such that fluid flow is directed from the second chamber 222 to the fourth chamber 224. When the second diverter 242 is in the first position, the fourth chamber 226 is fluidly disconnected connected from the second chamber 222, such that no fluid is directed into the fourth chamber 226 from the second chamber 222. For example, the second outlet member 138 (or a chamber leading thereto such as the third chamber 224) may be fluidly connected to the second chamber 222, when the second diverter 242 is in its first position (e.g., as shown in FIG. 16).

As shown in FIGS. 13-15, when the first diverter 240 is in the second position, the fluid flows from the inlet 130, to the first chamber 220, to the first outlet member 136 to provide the first spray function (e.g., high-velocity discharge, jet discharge, jet spray, a mode of operation, etc.) of the sprayhead 100. In some embodiments, when the first diverter 240 is the second position, the flow of fluid through the first chamber is independent of (e.g., unaffected by) the position of the second diverter 242.

As shown in FIGS. 16-18, when the first diverter 240 is in the first position and the second diverter 242 is in the first position, the fluid flows from the inlet 130 to the second chamber 222, to the third chamber 224, and to the second outlet member 138 to provide a second spray function (e.g., a low-velocity discharge, an aerated discharge, a mode of operation, etc.) of the sprayhead 100.

As shown in FIGS. 19-21, when the first diverter 240 is in the first position and the second diverter 242 is in the second position, the fluid flows from the inlet 130 to the second chamber 222, to the fourth chamber 226, to the third outlet member 140 to provide a third spray function (e.g., a sweep spray function, a shower spray function, a distributed spray function, a mode of operation, etc.) of the sprayhead 100. Thus, the plurality of nozzles of the third outlet member 140 are fluidly connected to the inlet 130 in this configuration.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

1. A fluid control valve assembly configured to be coupled to a fluid inlet and a fluid outlet assembly, the fluid control valve assembly comprising:
a first portion, a second portion, and a third portion, the portions being assembled to define a first chamber, a second chamber, a third chamber, and a fourth chamber, wherein each of the first, second, third, and fourth chambers is defined by a combination of at least two of the first, second, and third portions;
a first diverter movable within the fluid control valve assembly between a first position and a second position; and
a second diverter movable within the fluid control value assembly between a first position and a second position,
wherein, to selectively control flow of fluid through the fluid inlet, at least one chamber, and the fluid outlet assembly, the fluid control valve assembly is configured such that when the first diverter is in the first position, the fluid inlet is fluidly coupled with the second chamber, when the first diverter is in the second position, the fluid inlet is fluidly coupled with the first chamber, when the second diverter is in the first position, the second chamber is fluidly connected with the third chamber and, when the second diverter is in the second position, the second chamber is fluidly connected to the fourth chamber.

2. The fluid control valve of claim 1, wherein the first chamber is fluidly connectable with a first outlet member of the fluid outlet assembly.

3. The fluid control valve of claim 2, wherein the first outlet member includes at least one nozzle for providing a fluid stream output.

4. The fluid control valve of claim 1, wherein the third chamber is fluidly connectable with a second outlet member of the fluid outlet assembly.

5. The fluid control valve of claim 4, wherein the second outlet member is configured to provide an aerated fluid output.

6. The fluid control valve of claim 1, wherein the fourth chamber is fluidly connected with a third outlet member of the fluid outlet assembly.

7. The fluid control valve of claim 6, wherein the third outlet member includes a plurality of nozzles for providing a spray fluid output.

8. A fluid outlet device comprising:
a housing having a valve assembly at least partially housed therein, the valve assembly including a plurality of portions, which when combined, define a plurality of chambers, wherein each chamber of the plurality of chambers is formed by a combination of at least two portions of the plurality of portions;
a first actuator movable relative to the housing;
a second actuator movable relative to the housing; and
an outlet assembly coupled to the housing, the outlet assembly being configured to provide a plurality of spray functions,
wherein the valve assembly further includes a first diverter and a second diverter, the first diverter being coupled to the first actuator and the second diverter being coupled to the second actuator, the first diverter and the second diverter each being movable between a first position and a second position relative to the valve assembly upon actuation of the first and second actuators, respectively, wherein positioning of the first and second diverters determines a fluid path through the plurality of chambers.

9. The fluid outlet device of claim 8 wherein the outlet assembly is fluidly coupled to the valve assembly and is configured to receive a fluid from at least one chamber of the valve assembly based on the position of least one of the first diverter and the second diverter.

10. The fluid outlet device of claim 8, further comprising an inlet coupled to the housing, the inlet being configured to deliver fluid to the valve assembly, wherein, when the first diverter is in the second position, the inlet is fluidly coupled with a first chamber of the plurality of chambers.

11. The fluid outlet device of claim 10, wherein, when the first diverter is in the first position, the inlet is fluidly coupled with a second chamber of the plurality of chambers.

12. The fluid outlet device of claim 11, wherein when the second diverter is in the first position, the second chamber is fluidly connected with a third chamber of the plurality of chambers.

13. The fluid outlet device of claim 12, wherein when the second diverter is in the second position, the second chamber is fluidly connected to a fourth chamber of the plurality of chambers.

14. The fluid outlet device of claim 13, wherein:
when the first diverter is in the second position, and the second diverter is in either the first position or second position, the fluid outlet device is configured to flow fluid from the inlet to the first chamber, and from the first chamber to the outlet assembly to provide a first spray function of the fluid outlet device;
when the first diverter is in the first position, and the second diverter is in the first position, the fluid outlet device is configured to flow fluid from the inlet to the second chamber, from the second chamber to the third chamber, and from the third chamber to the outlet assembly to provide a second spray function of the fluid outlet device; and
when the first diverter is in the first position, and the second diverter is in the second position, the fluid outlet device is configured to flow fluid from the inlet to the second chamber, from the second chamber to the fourth chamber, and from the fourth chamber to the outlet assembly to provide a third spray function of the fluid outlet device.

15. A sprayhead comprising:
a housing, configured to house one or more elements of the sprayhead, the housing including an outer wall defining a cavity;
a valve assembly, at least partially housed within the cavity, the valve assembly including a plurality of portions, which when combined, define a plurality of chambers, wherein each chamber of the plurality of chambers is formed by a combination of at least two portions of the plurality of portions; and
a first opening disposed on a first end of the housing, and a second opening disposed on a second end of the housing;

16. The sprayhead of claim 15, further comprising an inlet area and an outlet area, wherein the housing partially extends between the inlet area and the outlet area.

17. The sprayhead of claim 15, wherein the valve assembly further comprises a first diverter and a second diverter, each movable between a first position and a second position to selectively control a flow of fluid through at least one of the chambers, and wherein the sprayhead further comprises a first actuator movable relative to the housing to shift the first diverter between the first and second positions, and a second actuator movable relative to the housing to shift the second diverter between the first and second positions.

18. The sprayhead of claim 15, wherein a cross sectional area of the housing is substantially circular, rectangular, oval, triangular, polygonal, or any combination thereof.

19. The sprayhead of claim 15, wherein the housing is made of a material or combination of hydrophobic or corrosion resistant materials selected from the group consisting of: stainless steel, aluminum, copper, bronze brass, plastic, glass, ceramic, resin, polymer, thermoset, thermoplastic, and combinations thereof.

20. The sprayhead of claim 15, the sprayhead further comprising an outlet assembly detachably couplable to one or more threads defined on an outer surface of the outer wall of the housing, the outlet assembly comprising an outer portion, an insert, a distributor, and an expander.
